(19) United States
(12) Patent Application Publication
(10) Pub. No.: US 2017/0037245 A1
(43) Pub. Date: Feb. 9, 2017

(54) POLYCARBONATE COMPOSITION

(71) Applicant: SABIC Global Technologies B.V., Bergen op Zoom (NL)

(72) Inventor: Karin Irene van de Wetering, Noord-Brabant (NL)

(21) Appl. No.: 15/305,569

(22) PCT Filed: Apr. 22, 2015
(86) PCT No.: PCT/IB2015/052924

§ 371 Date: Oct. 20, 2016

Related U.S. Application Data
(60) Provisional application No. 61/986,147, filed on Apr. 30, 2014.

(51) Int. Cl. C08L 69/00

(52) U.S. Cl. CPC C08L 69/00; C08L 2201/02; C08L 2205/025; C08L 2205/03; C08L 2201/08

(57) ABSTRACT

Polycarbonate blends with a combination of high thin wall flame retardance, CTI Class 2 tracking resistance, and high dimensional stability are disclosed. The blends are a combination of a polycarbonate polymer, a polycarbonate-polysiloxane co polymer, and a phosphazene flame retardant. The polycarbonate blends may be used in various applications.

### CROSS-REFERENCE TO RELATED APPLICATIONS

This application claims priority to U.S. Provisional Patent Application Ser. No. 61/986,147, filed Apr. 30, 2014. The disclosure of that application is hereby fully incorporated by reference herein.

### BACKGROUND

The present disclosure relates to polycarbonate compositions that have a combination of low temperature impact resistance, thin wall flame retardance (FR), good electrical tracking resistance, and reduced halogen content. These polycarbonate compositions can be useful for various applications.

Polycarbonates (PC) are synthetic engineering thermoplastic resins, and are a useful class of polymers having many beneficial properties. Polycarbonate resins are used for a number of different commercial applications, including electronic engineering (E&E) parts, mechanical parts and so on.

Because of their broad use, it is desirable to provide polycarbonates having good flame retardance. The market is also moving towards articles having thin walls for purposes of slimness, weight reduction, and size reduction of the overall final product, as well as more complex designs.

Desirably, polycarbonate compositions should also have good flow properties. Good flow properties reflect how easily the polymeric composition can be poured into a mold for forming the shape of the part. Better impact properties are also desirable. A conventional way of increasing stiffness is by increasing the weight average molecular weight of the polymer, but this typically also reduces the flow properties and makes it difficult to fill complex or thin-walled molds. Common flame retardant additives do not provide this balance between properties.

There remains a need in the art for flame retardant polycarbonate compositions that have good thin wall flame retardance, provide good electrical tracking resistance, and maintain ductility at low temperatures while providing the desired color. This need is especially apparent when high levels of TiO₂ are needed.

### BRIEF DESCRIPTION

Disclosed herein are polycarbonate blends which have a combination of thin wall FR ratings and high flow combined with retention in mechanical properties as shown by good dimensional stability. The blends include varying amounts of a polycarbonate polymer, a polycarbonate-polysiloxane copolymer, and a phosphazene flame retardant.

Disclosed in various embodiments are flame-retardant polycarbonate blends, comprising: from about 30 wt % to about 80 wt % of a polycarbonate polymer; a polycarbonate-polysiloxane copolymer in an amount such that the blend contains from about 2 wt % to about 5 wt % of siloxane; and a phosphazene flame retardant in an amount such that the blend contains from about 0.1 wt % to about 0.7 wt % of phosphorus; wherein the polycarbonate blend meets CTI PLC 2 standards and has V0 performance at 1.5 mm thickness.

More particularly, the polycarbonate blend may have V0 performance at 0.8 mm thickness.

The blend may have any combination of the following properties: pass the ball pressure test (BPT) at 125° C.; have 100% ductility at −30° C. when measured under Izod notched impact according to ISO 180; have an MVR of 8 cm³/10 min or higher when measured at 300° C., 1.2 kg according to ISO 1133; and have a notched Izod impact strength at −30° C. of at least 25 kJ/m² when measured according to ISO 180;

In particular embodiments, the blend has V0 performance at 0.8 mm thickness; has 100% ductility at −30° C. when measured under Izod notched impact according to ISO 180; has an MVR of 8 cm³/10 min or higher when measured at 300° C., 1.2 kg according to ISO 1133; and passes the BPT at 125° C.

In other embodiments, the blend has a pFTP(V0) of at least 0.90 and a flame out time (FOT) of about 30 seconds or less at 0.8 mm thickness.

Sometimes, the blend has a pFTP(V0) of at least 0.95 and a FOT of about 25 seconds or less at 0.8 mm thickness.

The polycarbonate blend can further comprise any combination of the following ingredients: from about 2 wt % to about 10 wt % of titanium dioxide (TiO₂); from about 14 wt % to about 24 wt % of the polycarbonate-polysiloxane copolymer; from about 1 wt % to about 4 wt % of the phosphazene flame retardant; and from about 0.2 wt % to about 0.6 wt % of an anti-drip agent.

In some particular variations, the polycarbonate polymer comprises a high molecular weight polycarbonate polymer having a Mw above 25,000 and a low molecular weight polycarbonate polymer having a Mw below 25,000. The weight ratio of the high molecular weight polycarbonate polymer to the low molecular weight polycarbonate polymer may be about 1:1.

The phosphazene flame retardant may have the structure of Formula (II) or Formula (III):

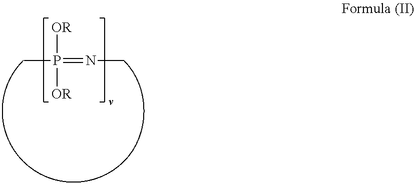

wherein R is alkyl or aryl; and wherein v is an integer from 3 to 25;

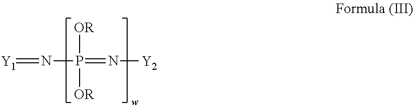

wherein R is alkyl or aryl; w is an integer from 3 to about 1,000; Y₁ is —P(OR)₃ or —P(═O)(OR); and Y₂ is —P(OR)₄ or —P(═O)(OR)₂.

The polycarbonate blend may further comprise from greater than 0 to 2 wt % of carbon black. In particular embodiments, the blend does not contain a copolymer of bisphenol-A and 2-phenyl-3,3-bis(4-hydroxyphenyl) phthalimidine.

Also disclosed herein are flame-retardant polycarbonate blends, comprising: from about 35 wt % to about 45 wt % of a high molecular weight polycarbonate polymer having a Mw above 25,000; from about 35 wt % to about 45 wt % of a low molecular weight polycarbonate polymer having a Mw below 25,000; from about 14 wt % to about 24 wt % of a polycarbonate-polysiloxane copolymer; from about 1.0 wt % to about 4.0 wt % of a phosphazene flame retardant; and from about 2.0 wt % to about 7.0 wt % of titanium dioxide (TiO₂); wherein the blend meets CTI PLC 2 standards, has V0 performance at 0.8 mm thickness, and passes the BPT at 125° C.

These and other non-limiting characteristics are more particularly described below.

### DETAILED DESCRIPTION

The present disclosure may be understood more readily by reference to the following detailed description of desired embodiments and the examples included therein. In the following specification and the claims which follow, reference will be made to a number of terms which shall be defined to have the following meanings.

The singular forms “a,” “an,” and “the” include plural referents unless the context clearly dictates otherwise.

As used in the specification and in the claims, the term “comprising” may include the embodiments “consisting of” and “consisting essentially of.”

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

As used herein, unless specifically stated otherwise, the test standards are the most recent standard available as of the date of Apr. 15, 2014.

As used herein, approximating language may be applied to modify any quantitative representation that may vary without resulting in a change in the basic function to which it is related. Accordingly, a value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.”

It should be noted that weight percentage or “wt %”, is based on the total weight of the polymeric composition.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, the aldehyde group —CHO is attached through the carbon of the carbonyl group.

The term “aliphatic” refers to a linear or branched array of atoms that is not cyclic and has a valence of at least one. Aliphatic groups are defined to comprise at least one carbon atom. The array of atoms may include heteroatoms such as nitrogen, sulfur, silicon, selenium and oxygen in the backbone or may be composed exclusively of carbon and hydrogen. Aliphatic groups may be substituted or unsubstituted. Exemplary aliphatic groups include, but are not limited to, methyl, ethyl, isopropyl, isobutyl, hydroxymethyl (—CH₂OH), mercaptomethyl (—CH₂SH), methoxy, methoxycarbonyl (CH₃OCO—), nitromethyl (—CH₂NO₂), and thiocarbonyl.

The term “alkyl” refers to a linear or branched array of atoms that is composed exclusively of carbon and hydrogen. The array of atoms may include single bonds, double bonds, or triple bonds (typically referred to as alkane, alkene, or alkyne). Alkyl groups may be substituted (i.e. one or more hydrogen atoms is replaced) or unsubstituted. Exemplary alkyl groups include, but are not limited to, methyl, ethyl, and isopropyl. It should be noted that alkyl is a subset of aliphatic.

The term “aromatic” refers to an array of atoms having a valence of at least one and comprising at least one aromatic group. The array of atoms may include heteroatoms such as nitrogen, sulfur, selenium, silicon and oxygen, or may be composed exclusively of carbon and hydrogen. Aromatic groups are not substituted. Exemplary aromatic groups include, but are not limited to, phenyl, pyridyl, furanyl, thienyl, naphthyl and biphenyl.

The term “aryl” refers to an aromatic radical composed entirely of carbon atoms and hydrogen atoms. When aryl is described in connection with a numerical range of carbon atoms, it should not be construed as including substituted aromatic radicals. For example, the phrase “aryl containing from 6 to 10 carbon atoms” should be construed as referring to a phenyl group (6 carbon atoms) or a naphthyl group (10 carbon atoms) only, and should not be construed as including a methylphenyl group (7 carbon atoms). It should be noted that aryl is a subset of aromatic.

The term “cycloaliphatic” refers to an array of atoms which is cyclic but which is not aromatic. The cycloaliphatic group may include heteroatoms such as nitrogen, sulfur, selenium, silicon and oxygen in the ring, or may be composed exclusively of carbon and hydrogen. A cycloaliphatic group may comprise one or more noncyclic components. For example, a cyclohexylmethyl group (C₆H₁₁CH₂—) is a cycloaliphatic functionality, which comprises a cyclohexyl ring (the array of atoms which is cyclic but which is not aromatic) and a methylene group (the noncyclic component). Cycloaliphatic groups may be substituted or unsubstituted. Exemplary cycloaliphatic groups include, but are not limited to, cyclopropyl, cyclobutyl, 1,1,4,4-tetramethylcyclobutyl, piperidinyl, and 2,2,6,6-tetramethylpiperydinyl.

The term “cycloalkyl” refers to an array of atoms which is cyclic but is not aromatic, and which is composed exclusively of carbon and hydrogen. Cycloalkyl groups may be substituted or unsubstituted. It should be noted that cycloalkyl is a subset of cycloaliphatic.

In the definitions above, the term “substituted” refers to at least one hydrogen atom on the named radical being substituted with another functional group, such as alkyl, halogen, —OH, —CN, —NO₂, —COOH, etc.

The term “perfluoroalkyl” refers to a linear or branched array of atoms that is composed exclusively of carbon and fluorine.

The term “room temperature” refers to a temperature of 23° C.

One method of measuring colors is the CIELAB color space. This color space uses three dimensions, L*, a*, and b*. L* is the lightness or L-value, and can be used as a measure of the amount of light transmission through the polycarbonate resin. The values for L*range from 0 (black) to 100 (diffuse white). The dimension a* is a measure of the color between magenta (positive values) and green (negative values). The dimension b* is a measure of the color between yellow (positive values) and blue (negative values), and may also be referred to as measuring the blueness of the color or as the b-value. Colors may be measured under DREOLL conditions.

As used herein, unless specifically stated otherwise, the test standards are the most recent standard available as of the date of Apr. 15, 2014.

The polycarbonate blends of the present disclosure include (A) at least one polycarbonate polymer; (B) a polycarbonate-polysiloxane copolymer; and (C) a phosphazene flame retardant additive. In additional embodiments, the blends also include (D) titanium dioxide. The resulting blends have a combination of desirable properties, specifically good tracking resistance, good thin-wall flame retardance (FR), and good dimensional stability.

As used herein, the terms “polycarbonate” and “polycarbonate polymer” mean a polymer having repeating structural carbonate units of the formula (1):

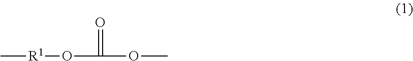

in which at least about 60 percent of the total number of R¹ groups are aromatic organic radicals and the balance thereof are aliphatic, alicyclic, or aromatic radicals. An ester unit (—COO—) is not considered a carbonate unit, and a carbonate unit is not considered an ester unit. In one embodiment, each R¹ is an aromatic organic radical, for example a radical of the formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, wherein R¹ is as defined above. Dihydroxy compounds suitable in an interfacial reaction include the dihydroxy compounds of formula (A) as well as dihydroxy compounds of formula (3)

HO-A¹-Y¹-A²-OH (3)

wherein Y¹, A¹ and A² are as described above. Also included are bisphenol compounds of general formula (4):

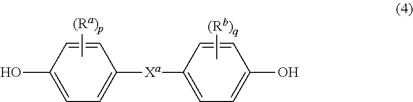

wherein R^{a} and R^{b} each represent a halogen atom or a monovalent hydrocarbon group and may be the same or different; p and q are each independently integers of 0 to 4; and X^{a} represents one of the groups of formula (5):

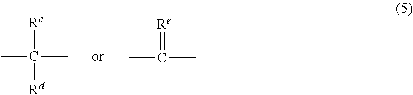

wherein R^{c} and R^{d} each independently represent a hydrogen atom or a monovalent linear or cyclic hydrocarbon group and R^{e} is a divalent hydrocarbon group.

Specific examples of the types of bisphenol compounds that may be represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol-A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, and 2-phenyl-3,3-bis(4-hydroxyphenyl) phthalimidine (“PPPBP”). Combinations comprising at least one of the foregoing dihydroxy compounds may also be used.

Branched polycarbonates are also useful, as well as blends of a linear polycarbonate and a branched polycarbonate. The branched polycarbonates may be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane (THPE), isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 wt % to about 2.0 wt %.

“Polycarbonate” and “polycarbonate polymer” as used herein further includes blends of polycarbonates with other copolymers comprising carbonate chain units. An exemplary copolymer is a polyester carbonate, also known as a copolyester-polycarbonate. Such copolymers further contain, in addition to recurring carbonate chain units of the formula (1), repeating units of formula (6):

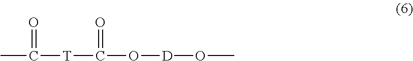

wherein D is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T is a divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical. In other embodiments, dicarboxylic acids that contain a C4-C36 alkylene radical may be used to form copolymers of formula (6). Examples of such alkylene radicals include adipic acid, sebacic acid, or dodecanoic acid.

In one embodiment, D is a C₂₋₆ alkylene radical. In another embodiment, D is derived from an aromatic dihydroxy compound of formula (7):

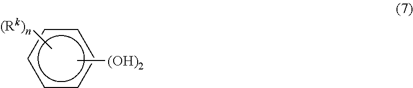

wherein each R^{k} is independently a C₁₋₁₀ hydrocarbon group, and n is 0 to 4. The halogen is usually bromine. Examples of compounds that may be represented by the formula (7) include resorcinol, substituted resorcinol compounds such as 5-methyl resorcinol, 5-phenyl resorcinol, 5-cumyl resorcinol, or the like; catechol; hydroquinone; substituted hydroquinones such as 2-methyl hydroquinone, 2-t-butyl hydroquinone, 2-phenyl hydroquinone, 2-cumyl hydroquinone, 2,3,5,6-tetramethyl hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof.

In other embodiments, poly(alkylene terephthalates) may be used. Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters.

Copolymers comprising alkylene terephthalate repeating ester units with other ester groups may also be useful. Useful ester units may include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s may also include poly(alkylene cyclohexanedicarboxylate)s. Of these, a specific example is poly(1,4-cyclohexanedimethanol-1,4-cyclohexanedicarboxylate) (PCCD), having recurring units of formula (8):

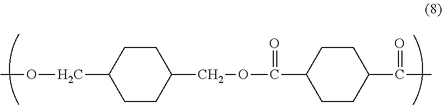

wherein, as described using formula (6), R² is a 1,4-cyclohexanedimethylene group derived from 1,4-cyclohexanedimethanol, and T is a cyclohexane ring derived from cyclohexanedicarboxylate or a chemical equivalent thereof, and may comprise the cis-isomer, the trans-isomer, or a combination comprising at least one of the foregoing isomers.

In specific embodiments of the present disclosure, the polycarbonate polymer (A) is derived from a dihydroxy compound having the structure of Formula (I):

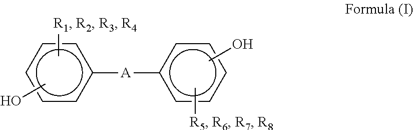

wherein R₁ through R₈ are each independently selected from hydrogen, nitro, cyano, C₁-C₂₀ alkyl, C₄-C₂₀ cycloalkyl, and C₆-C₂₀ aryl; and A is selected from a bond, —O—, —S—, —SO₂—, C₁-C₁₂ alkyl, C₆-C₂₀ aromatic, and C₆-C₂₀ cycloaliphatic.

In specific embodiments, the dihydroxy compound of Formula (I) is 2,2-bis(4-hydroxyphenyl) propane (i.e. bisphenol-A or BPA). Other illustrative compounds of Formula (I) include: 2,2-bis(4-hydroxy-3-isopropylphenyl)propane; 2,2-bis(3-t-butyl-4-hydroxyphenyl)propane; 2,2-bis(3-phenyl-4-hydroxyphenyl)propane; 1,1-bis(4-hydroxyphenyl)cyclohexane; 4,4′dihydroxy-1,1-biphenyl; 4,4′-dihydroxy-3,3′-dimethyl-1,1-biphenyl; 4,4′-dihydroxy-3,3′-dioctyl-1,1-biphenyl; 4,4′-dihydroxydiphenylether; 4,4′-dihydroxydiphenylthioether; and 1,3-bis(2-(4-hydroxyphenyl)-2-propyl)benzene.

In more specific embodiments, the polycarbonate polymer (A) is a bisphenol-A homopolymer. The polycarbonate polymer may have a weight average molecular weight (Mw) of from about 15,000 to about 70,000 daltons, according to polycarbonate standards, including a range of from about 15,000 to about 22,000 daltons. The polycarbonate polymer can be a linear or branched polycarbonate, and in more specific embodiments is a linear polycarbonate.

In some embodiments of the present disclosure, the polycarbonate composition includes two polycarbonate polymers, i.e. a first polycarbonate polymer (A1) and a second polycarbonate polymer (A2). The two polycarbonate polymers may have the same or different monomers.

The first polycarbonate polymer has a greater weight average molecular weight than the first polycarbonate polymer. The first polycarbonate polymer may have a weight average molecular weight of above 25,000 (measured by GPC based on BPA polycarbonate standards). The second polycarbonate polymer may have a weight average molecular weight of below 25,000 (measured by GPC based on BPA polycarbonate standards). In embodiments, the weight ratio of the first polycarbonate polymer to the second polycarbonate polymer is usually at least 0.5:1, and in further embodiments is at least 1:1. Note the weight ratio described here is the ratio of the amounts of the two copolymers in the blend, not the ratio of the molecular weights of the two copolymers. The weight ratio between the two polycarbonate polymers can affect the flow properties, ductility, and surface aesthetics of the final blend. The blends may include from about 30 to about 80 wt % of the first polycarbonate polymer and the second polycarbonate polymer. The blend may contain from about 35 to about 45 wt % of the first polycarbonate polymer. The blend may contain from about 35 to about 45 wt % of the second polycarbonate polymer. In specific embodiments, the blend contains from about 35 to about 40 wt % of the first polycarbonate polymer and from about 35 to about 40 wt % of the second polycarbonate polymer.

Suitable polycarbonates can be manufactured by processes known in the art, such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst in a Banbury™ mixer, twin screw extruder, or the like to form a uniform dispersion. Volatile monohydric phenol is removed from the molten reactants by distillation and the polymer is isolated as a molten residue.

The polycarbonate compositions of the present disclosure also contain a polycarbonate-polysiloxane copolymer (B). This copolymer comprises polycarbonate blocks and polydiorganosiloxane blocks, also known as a polycarbonate-polysiloxane copolymer. The polycarbonate blocks in the copolymer comprise repeating structural units of formula (1) as described above, for example wherein R¹ is of formula (2) as described above. These units may be derived from reaction of dihydroxy compounds of formula (3) as described above.

The polydiorganosiloxane blocks comprise repeating structural units of formula (9) (sometimes referred to herein as ‘siloxane’):

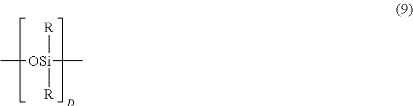

wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer. Generally, D may have an average value of 2 to about 1000, specifically about 2 to about 500, more specifically about 5 to about 200, and more specifically about 10 to about 75. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer.

In one embodiment, the polydiorganosiloxane blocks are provided by repeating structural units of formula (10):

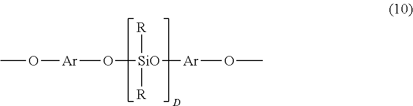

wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (10) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used.

Such units may be derived from the corresponding dihydroxy compound of the following formula (11):

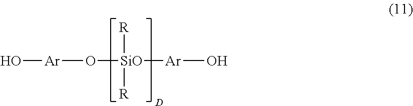

wherein Ar and D are as described above. Compounds of this formula may be obtained by the reaction of a dihydroxyarylene compound with, for example, an alpha, omega-bisacetoxypolydiorangonosiloxane under phase transfer conditions.

In another embodiment the polydiorganosiloxane blocks comprise repeating structural units of formula (12):

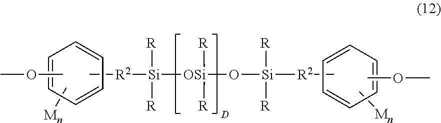

wherein R and D are as defined above. R² in formula (12) is a divalent C₂-C₈ aliphatic group. Each M in formula (12) may be the same or different, and may be cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is an alkyl group such as methyl, ethyl, or propyl, an alkoxy group such as methoxy, ethoxy, or propoxy, or an aryl group such as phenyl, or tolyl; R² is a dimethylene, trimethylene or tetramethylene group; and R is a C₁₋₈ alkyl, haloalkyl such as trifluoropropyl, cyanoalkyl, or aryl such as phenyl or tolyl. In another embodiment, R is methyl, or a mixture of methyl and phenyl. In still another embodiment, M is methoxy, n is one, R² is a divalent C₁-C₃ aliphatic group, and R is methyl.

These units may be derived from the corresponding dihydroxy polydiorganosiloxane (13):

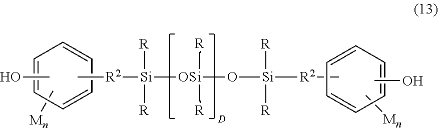

wherein R, D, M, R², and n are as described above.

Such dihydroxy polysiloxanes can be made by effecting a platinum catalyzed addition between a siloxane hydride of the formula (14),

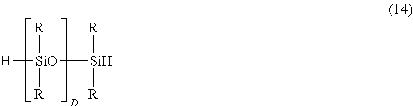

wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-t-butoxyphenol, 4-phenyl-2-phenylphenol, 2-methyl-4-propylphenol, 2-allyl-4,6-dimethylphenol, 2-allyl-6-methoxy-4-methylphenol and 2-allyl-4,6-dimethylphenol. Mixtures comprising at least one of the foregoing may also be used.

The siloxane blocks may make up from greater than zero to about 25 wt % of the polycarbonate-polysiloxane copolymer, including from 4 wt % to about 25 wt %, from about 4 wt % to about 10 wt %, or from about 15 wt % to about 25 wt %. The polycarbonate blocks may make up from about 75 wt % to less than 100 wt % of the block copolymer, including from about 75 wt % to about 85 wt %. It is specifically contemplated that the polycarbonate-polysiloxane copolymer is a diblock copolymer. The polycarbonate-polysiloxane copolymer may have a weight average molecular weight of from about 28,000 to about 32,000. Desirably, the blend contains an amount of polycarbonate-polysiloxane copolymer such that the blend contains from about 2 wt % to about 5 wt % of siloxane. The blend may contain from about 14 to about 24 wt % of the polycarbonate-polysiloxane copolymer.

The polycarbonate blends of the present disclosure also include a phosphazene flame retardant additive (C). This flame retardant does not contain bromine or chlorine. The flame retardant additive (C) is present in the blend in an amount such that the blend contains from about 0.1 wt % to about 0.7 wt % of phosphorus. Depending on the phosphazene that is used, the flame retardant additive may be from about 1.0 percent to about 4.0 percent by weight of the blend, or from about 3 wt % to about 4 wt %. More than one flame retardant additive may be present, i.e. combinations of such additives are contemplated.

In embodiments, the phosphazene flame retardant may be a cyclic phosphazene of Formula (II) or a linear phosphazene of Formula (III):

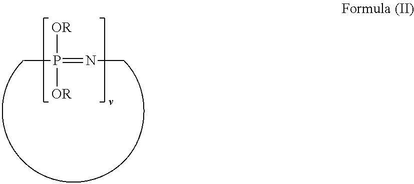

wherein R is alkyl or aryl; and wherein v is an integer from 3 to 25;

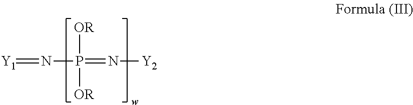

wherein R is alkyl or aryl; w is an integer from 3 to about 1,000; Y₁ is —P(OR)₃ or —P(═O)(OR); and Y₂ is —P(OR)₄ or —P(═O)(OR)₂. In particular embodiments of both Formula (II) and Formula (III), R is phenyl (—C₆H₅). These phosphazenes can also be crosslinked. An exemplary phosphazene flame retardant is SPB-100, a diphenoxyphosphazene commercially available from Otsuka Chemical Co., Ltd., believed to be a phosphazene of Formula (II) where R=phenyl and v=3.

In some embodiments of the present disclosure, the polycarbonate blends of the present disclosure also comprise titanium dioxide (D). The titanium dioxide has an average particle size of from about 30 nm to about 500 nm, including from about 100 nm to about 500 nm, or from about 150 nm to about 500 nm, or from about 100 nm to about 250 nm, or from about 150 nm to about 200 nm, or from about 30 nm to about 180 nm. In some embodiments, the titanium dioxide particles may be coated, for example with a silicon-based coating. The titanium dioxide may be present in the blends of the present disclosure in amounts of up to about 10 wt %, including from about 2 to about 10 wt % or from about 2 to about 7 wt %.

In particular embodiments, the blend also comprises an anti-drip agent (E). Anti-drip agents include, for example a fibril forming or non-fibril forming fluoropolymer such as polytetrafluoroethylene (PTFE). The anti-drip agent may be encapsulated by a rigid copolymer as described above, for example SAN. PTFE encapsulated in SAN is known as TSAN. Encapsulated fluoropolymers may be made by polymerizing the encapsulating polymer in the presence of the fluoropolymer, for example, in an aqueous dispersion. TSAN may provide significant advantages over PTFE, in that TSAN may be more readily dispersed in the composition. A suitable TSAN may comprise, for example, about 50 wt % PTFE and about 50 wt % SAN, based on the total weight of the encapsulated fluoropolymer. The SAN may comprise, for example, about 75 wt % styrene and about 25 wt % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer. The anti-drip agent can be present in an amount of from about 0.05 wt % to about 1 wt % of the blend.

The polycarbonate blend may also include carbon black (F). When present (i.e. in greater than zero amounts), the blend may contain up to 2 wt % carbon black, or may contain up to 1.5 wt % carbon black.

Generally, the polycarbonate blends of the present disclosure comprise from about 30 wt % to about 80 wt % of the polycarbonate polymer (A); a sufficient amount of the polycarbonate-polysiloxane copolymer (B) so that the blend contains about 2 wt % to about 5 wt % of siloxane; and a sufficient amount of the phosphazene flame retardant (C) so that the blend contains about 0.1 wt % to about 0.7 wt % of phosphorus. In particular embodiments, the polycarbonate blends of the present disclosure comprise from about 30 wt % to about 80 wt % of the polycarbonate polymer (A); from about 14 wt % to about 24 wt % of the polycarbonate-polysiloxane copolymer (B); and from about 1 wt % to about 4 wt % of the phosphazene flame retardant (C). It should be noted that the at least one polycarbonate polymer (A) may be a blend of two or more polycarbonate polymers having different weight average molecular weights, and the recited about 30 wt % to about 80 wt % refers to the total amount of such polycarbonate polymers (A) in the blend. When present, the blends can comprise from about 2 wt % to about 6 wt % of the titanium dioxide (D); and from about 0.2 wt % to about 0.6 wt % of the antidrip agent (E).

In more specific embodiments, the polycarbonate blend may comprise from about 15 wt % to about 20 wt % of the polycarbonate-polysiloxane copolymer (B). In more specific embodiments, the polycarbonate blend may comprise from about 3 wt % to about 4 wt % of the flame retardant additive (C). In more specific embodiments, the polycarbonate blend may comprise from about 2 wt % to about 7 wt % of the titanium dioxide (D). The polycarbonate blends of the present disclosure may have any combination of these amounts for these ingredients.

The polycarbonate blends of the present disclosure have a combination of low temperature impact resistance, flame retardance at thin wall thicknesses, good tracking resistance, good impact strength, and good flow properties.

The polycarbonate blends of the present disclosure may have 100% ductility at −30° C., when measured under Izod notched impact according to ISO 180. This serves as a proxy for determining whether the material will shatter rather than bending or deforming. It is noted that the ductility is measured using the Izod notched impact test according to ISO 180, and the ductility is specifically not measured using the multiaxial impact (MAI) test of ISO 6603. These two tests will result in different measurements for the same composition.

The polycarbonate blends of the present disclosure may achieve V0 performance at a thickness of 1.5 millimeters (mm), when measured according to UL94. They can also achieve V0 performance at a thickness of 1.0 mm or 0.8 mm. In other embodiments, the polycarbonate blends have a specified pFTP and FOT. These are discussed in the Examples herein. In some embodiments, the polycarbonate blends have a pFTP(V0) of at least 0.90 and a FOT of about 30 seconds or less, when measured at a thickness of 0.8 mm. In other embodiments, the polycarbonate blends have a pFTP(V0) of at least 0.95 and a FOT of about 25 seconds or less, again when measured at 0.8 mm thickness.

The polycarbonate blends of the present disclosure may have a tracking resistance that meets CTI PLC 2 standards. CTI (Comparative Tracking Index) is used to define the tendency of an electrical insulating material to fail due to tracking. Tracking is the process that produces a partially conducting path of localized deterioration on the surface of an insulating material as a result of the action of electric discharges on or close to an insulation surface. Failure occurs by shorting. Electrical tracking in a plastic can be a source of fire in plastic parts that are used in electrical applications, so tracking resistance is often an important safety requirement for a plastic.

The standard for CTI is ASTM D3638. Briefly, under this standard a square test piece (6 cm×6 cm) having a thickness of 3 mm is provided. Two electrodes are attached to the test piece, and a voltage is applied. Drops of 0.1% ammonium chloride solution (volume 20 mm³/drop) are applied between the electrodes, and the number of drops needed to cause tracking is counted. At each voltage, five specimens are tested, and the average number of drops is recorded. This procedure is repeated at four or more different voltages, and two data points should have more than 50 drops and two data points should have less than 50 drops. Then, a graph of the number of drops vs. voltage is plotted using those data points, and the voltage at which 50 drops causes tracking is extrapolated. If the extrapolated voltage is 250 volts or higher, then CTI PLC 2 standards have been met.

The standard test method described above can be somewhat long and cumbersome. A shorthand method is to apply a voltage of 250 volts and then continue to apply drops until tracking occurs. If 50 or more drops are needed to cause tracking, then this is a good sign that CTI PLC 2 standards will be met using the standard test method of ASTM D3638. For purposes of this application, CTI PLC 2 standards are considered to be met if either (i) the shorthand method is used and 50 or more drops are needed to cause tracking; or (ii) the standard test method of ASTM D3638 is followed.

The polycarbonate blends of the present disclosure can pass a ball point pressure (BPT) test at 125° C. This test measures the relationship between the degree of deformation and the temperature when a test specimen is subjected to a constant load, and is related to the Vicat softening temperature. The standard for the BPT is IEC 60335-1. Briefly, a test piece having a thickness of 3 mm is provided. A ball of diameter 5 mm is subjected to a load of 20 newtons for 60 minutes at the stated temperature, and the diameter of the resulting indentation is then measured. If the indentation has a diameter of less than 2 mm, then the ball pressure test is passed at the stated temperature. If the indentation has a diameter of 2 mm or greater, then the ball pressure test is failed at the stated temperature.

The polycarbonate blends of the present disclosure may exhibit a notched Izod impact strength (INI) measured according to ISO 180 of at least 20 kiloJoules per square meter (kJ/m²), when measured at −30° C., 5 kilograms (kg), and 3.0 mm thickness. In some embodiments, the notched Izod impact strength of the composition is at least 25 kJ/m², or at least 30 kJ/m², or at least 35 kJ/m², or at least 40 kJ/m², or at least 45 kJ/m², or at least 50 kJ/m². The INI may have a maximum of about 70 kJ/m².

The polycarbonate blends of the present disclosure may have a melt volume rate (MVR) of 8 cubic centimeters per 10 minutes (cc/10 min) or higher when measured according to ISO 1133 at 300° C. and a 1.2 kg load. In some embodiments, the MVR is 10 cc/10 min or higher. The MVR may reach a maximum of about 15 cc/10 minutes. It should be noted that a higher MVR is desirable, and that polycarbonate blends having an MVR greater than 15 cc/10 min should also be considered within the scope of this disclosure.

The polycarbonate blends of the present disclosure may have any combination of these properties (FR performance, tracking resistance, BPT, INI, MVR), and any combination of the listed values for these properties. It should be noted that some of the properties (e.g. INI) are measured using articles made from the polycarbonate blend; however, such properties are described as belonging to the polycarbonate blend for ease of reference.

In some specific embodiments, the blend meets CTI PLC 2 standards; and has V0 performance at 1.5 mm thickness. In other specific embodiments, the blend meets CTI PLC 2 standards; and has V0 performance at 0.8 mm thickness.

In some specific embodiments, the blend meets CTI PLC 2 standards; has V0 performance at 1.5 mm thickness; and passes the ball pressure test at 125° C. In other specific embodiments, the blend meets CTI PLC 2 standards; has V0 performance at 0.8 mm thickness; and passes the ball pressure test at 125° C.

In some specific embodiments, the blend meets CTI PLC 2 standards; has V0 performance at 1.5 mm thickness; and has 100% ductility at −30° C. when measured according to ISO 180. In other specific embodiments, the blend meets CTI PLC 2 standards; has V0 performance at 0.8 mm thickness; and has 100% ductility at −30° C. when measured according to ISO 180.

In some specific embodiments, the blend meets CTI PLC 2 standards; has V0 performance at 1.5 mm thickness; and has an MVR of 8 cc/10 min or higher at 300° C., 1.2 kg. In other specific embodiments, the blend meets CTI PLC 2 standards; has V0 performance at 0.8 mm thickness; and has an MVR of 8 cc/10 min or higher at 300° C., 1.2 kg.

In some specific embodiments, the blend meets CTI PLC 2 standards; has V0 performance at 1.5 mm thickness; and a notched Izod impact strength at −30° C. of at least 30 kJ/m². In other specific embodiments, the blend meets CTI PLC 2 standards; has V0 performance at 0.8 mm thickness; and a notched Izod impact strength at −30° C. of at least 30 kJ/m².

In some specific embodiments, the blend meets CTI PLC 2 standards; has V0 performance at 1.5 mm thickness; has 100% ductility at −30° C. when measured according to ISO 180; has an MVR of 8 cc/10 min or higher at 300° C., 1.2 kg; and passes the ball pressure test at 125° C. In other specific embodiments, the blend meets CTI PLC 2 standards; has V0 performance at 0.8 mm thickness; has 100% ductility at −30° C. when measured according to ISO 180; has an MVR of 8 cc/10 min or higher at 300° C., 1.2 kg; and passes the ball pressure test at 125° C.

In some specific embodiments, the blend meets CTI PLC 2 standards; has V0 performance at 1.5 mm thickness; and has a pFTP(V0) of at least 0.90 and a FOT of about 30 seconds or less at 0.8 mm thickness. In other specific embodiments, the blend meets CTI PLC 2 standards; has V0 performance at 0.8 mm thickness; and has a pFTP(V0) of at least 0.95 and a FOT of about 25 seconds or less at 0.8 mm thickness.

As used herein, unless specified otherwise, all standards are the most recent version as of the date of Apr. 15, 2014.

Other additives ordinarily incorporated in polycarbonate blends of this type can also be used, with the proviso that the additives are selected so as to not significantly adversely affect the desired properties of the polycarbonate. Combinations of additives can be used. Such additives can be mixed at a suitable time during the mixing of the components for forming the composition. In embodiments, one or more additives are selected from at least one of the following: UV stabilizing additives, thermal stabilizing additives, mold release agents, and gamma-stabilizing agents.

Exemplary antioxidant additives include, for example, organophosphites such as tris(nonyl phenyl)phosphite, tris(2,4-di-t-butylphenyl)phosphite (e.g., “IRGAFOS 168” or “1-168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of 0.0001 to 1 wt % of the overall polycarbonate composition.

Exemplary heat stabilizer additives include, for example, organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers are generally used in amounts of 0.0001 to 1 wt % of the overall polycarbonate composition.

Light stabilizers and/or ultraviolet light (UV) absorbing additives can also be used. Exemplary light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers are generally used in amounts of 0.0001 to 1 wt % of the overall polycarbonate composition.

Exemplary UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3, 3-diphenylacryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than or equal to 100 nanometers; or the like, or combinations comprising at least one of the foregoing UV absorbers. UV absorbers are generally used in amounts of 0.0001 to 1 wt % of the overall polycarbonate composition.

Plasticizers, lubricants, and/or mold release agents can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; waxes such as beeswax, montan wax, paraffin wax, or the like. Such materials are generally used in amounts of 0.001 to 1 wt %, specifically 0.01 to 0.75 wt %, more specifically 0.1 to 0.5 wt % of the overall polycarbonate composition.

Radiation stabilizers can also be present, specifically gamma-radiation stabilizers. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-pene-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH2OH) or it can be a member of a more complex hydrocarbon group such as —CR⁴HOH or —CR⁴OH wherein R⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl benzyl alcohol. 2-Methyl-2,4-pentanediol, polyethylene glycol, and polypropylene glycol are often used for gamma-radiation stabilization. Gamma-radiation stabilizing compounds are typically used in amounts of 0.1 to 10 wt % of the overall polycarbonate composition.

The polycarbonate compositions of the present disclosure may be molded into pellets. The compositions may be molded, foamed, or extruded into various structures or articles by known methods, such as injection molding, overmolding, extrusion, rotational molding, blow molding and thermoforming.

In particular, it is contemplated that the polycarbonate compositions of the present disclosure are used to mold thin-wall articles, particularly for electrical application. Non-limiting examples of such articles include a solar apparatus, an electrical junction box, an electrical connector, an electrical vehicle charger, an outdoor electrical enclosure, a smart meter enclosure, a smart grid power node, a photovoltaic frame, and a miniature circuit breaker.

The present disclosure further contemplates additional fabrication operations on said articles, such as, but not limited to, molding, in-mold decoration, baking in a paint oven, lamination, and/or thermoforming. The polycarbonate compositions are especially useful for making articles that have parts with a wall thickness of 1.0 mm or less, or 0.8 mm or less. It is recognized that molded parts can have walls that vary in thickness, and these values refer to the thinnest parts of those walls, or the “thinnest thickness”. Put another way, the article has at least one wall that is 1.0 mm/0.8 mm or less in thickness.

The following examples are provided to illustrate the polycarbonate blends of the present disclosure. The examples are merely illustrative and are not intended to limit the disclosure to the materials, conditions, or process parameters set forth therein.

### EXAMPLES

The following Table lists the names and descriptions of the ingredients used in the following Examples.

| | | | Trade | |
|---|---|---|---|---|
| Ingredient | Description | Mw | name | Supplier |
| PC-1 | Bisphenol-A homopolymer | 30,000-31,000 | LEXAN | SABIC |
| | | | | Innovative |
| | | | | Plastics |
| PC-2 | Bisphenol-A homopolymer | 21,000-22,000 | LEXAN | SABIC |
| | | | | Innovative |
| | | | | Plastics |
| PC-ST | An opaque BPA polycarbonate- | 30,000 | LEXAN | SABIC |
| | polydimethylsiloxane copolymer | | | Innovative |
| | comprising about 20% by weight of | | | Plastics |
| | siloxane, 80% by weight of BPA, | | | |
| | PCP (p-cumylphenol) endcapped, | | | |
| | siloxane chain length is ~35-55 | | | |
| BPADP | Bisphenol A diphosphate (8.9% P) | | NcendX | Albemarle |
| | | | P-30 | |
| DPP | Diphenoxyphosphazene (13% P) | | SPB-100 | Otsuka |
| | | | | Chemical |
| | | | | Co., Ltd. |
| TSAN | SAN encapsulated PTFE | | TSAN | SABIC |
| | | | | Innovative |
| | | | | Plastics |
| PETS | Pentaerythritol tetrastearate, >90% | | PETS G | Faci |
| | esterified, mold release agent | | | |
| Phosphite | Tris(2,4-di-tert- | | Irgafos | Ciba |
| | butylphenyl)phosphite | | 168 | |
| UVA 234 | 2-(2-hydroxy-3,5-dicumyl) | | TINUVIN | Ciba |
| | benzotriazole | | 234 | |
| TiO2 | Titanium dioxide | | KRONOS | Kronos |
| | | | 2233 | |
| CB | Carbon black | | Printex 85 | Degussa |

The melt volume rate (MVR) was measured using ISO 1133 at 300° C., 1.2 kg load. MVR is reported in cubic centimeters (cc) of polymer melt/10 minutes.

The notched Izod impact strength (INI) was measured using ISO 180, 5 kg, 23° C., and 3.0 mm thickness. INI was measured at 23° C. and at −30° C. to test for low temperature impact/ductility.

Flammability tests were performed following the procedure of Underwriter's Laboratory Bulletin 94 entitled “Tests for Flammability of Plastic Materials, UL94.” According to this procedure, materials may be classified as V-0, V-1 or V-2 on the basis of the test results obtained for samples of a given thickness. It is assumed that a material that meets a given standard at a given thickness can also meet the same standard at greater thicknesses (e.g. a material that obtains V0 performance at 0.8 mm thickness can also obtain V0 performance at 1.0 mm thickness, 1.5 mm, etc.). The samples are made according to the UL94 test procedure. Samples were burned in a vertical orientation after aging for 48 hours at 23° C. At least 10 injection molded bars were burned for each UL test. The criteria for each of the flammability classifications tested are described below.

V0: In a sample placed so that its long axis is 180 degrees to the flame, the average period of flaming and/or smoldering after removing the igniting flame does not exceed five seconds and none of the vertically placed samples produces drips of burning particles that ignite absorbent cotton, and no specimen burns up to the holding clamp after flame or after glow. Five bars FOT is the sum of the flame out time for five bars each lit twice for ten (10) seconds each, for a maximum flame out time of 50 seconds. FOT1 is the average flame out time after the first light. FOT2 is the average flame out time after the second light.

V-1, V-2: In a sample placed so that its long axis is 180 degrees to the flame, the average period of flaming and/or smoldering after removing the igniting flame does not exceed twenty-five seconds and, for a V-1 rating, none of the vertically placed samples produces drips of burning particles that ignite absorbent cotton. The V2 standard is the same as V-1, except that flaming drips that ignite the cotton are permitted. Five bar flame out time (FOT) is the sum of the flame out time for five bars, each lit twice for ten (10) seconds each, for a maximum flame out time of 250 seconds.

The data was also analyzed by calculating the average flame out time, standard deviation of the flame out time and the total number of drips, and by using statistical methods to convert that data to a prediction of the probability of first time pass, or “p(FTP)”, that a particular sample formulation would achieve a “pass” rating in the conventional UL94 V0 or V1 testing of 5 bars. The probability of a first time pass on a first submission (pFTP) may be determined according to the formula:

PFTP=(P_{t1>mbt,n=0}×P_{t2>mbt,n=0}×P_{total<=mtbt}×_{P drip,n=0})

where P_{t1>mbt, n=0} is the probability that no first burn time exceeds a maximum burn time value, P_{t2>mbt, n=0} is the probability that no second burn time exceeds a maximum burn time value, P_{total<=mtbt} is the probability that the sum of the burn times is less than or equal to a maximum total burn time value, and P_{drip, n=0} is the probability that no specimen exhibits dripping during the flame test. First and second burn time refer to burn times after a first and second application of the flame, respectively.

The probability that no first burn time exceeds a maximum burn time value, P_{t1>mbt, n=0}, may be determined from the formula: P_{t1>mbt, n=0}=(1−P_{t1>mbt})⁵ where P_{t1>mbt} is the area under the log normal distribution curve for t1>mbt, and where the exponent “5” relates to the number of bars tested. The probability that no second burn time exceeds a maximum burn time value may be determined from the formula: P_{t2>mbt, n=0}=(1-P_{t2>mbt}) where P_{t2>mbt} is the area under the normal distribution curve for t2>mbt. As above, the mean and standard deviation of the burn time data set are used to calculate the normal distribution curve. For the UL-94 V-0 rating, the maximum burn time is 10 seconds. For a V-1 or V-2 rating the maximum burn time is 30 seconds. The probability P_{drip, n=0} that no specimen exhibits dripping during the flame test is an attribute function, estimated by: (1-P_{drip})⁵ where P_{drip}=(the number of bars that drip/the number of bars tested).

The probability P_{total<=mtbt} that the sum of the burn times is less than or equal to a maximum total burn time value may be determined from a normal distribution curve of simulated 5-bar total burn times. The distribution may be generated from a Monte Carlo simulation of 1000 sets of five bars using the distribution for the burn time data determined above. Techniques for Monte Carlo simulation are well known in the art. A normal distribution curve for 5-bar total burn times may be generated using the mean and standard deviation of the simulated 1000 sets. Therefore, P_{total<=mtbt} may be determined from the area under a log normal distribution curve of a set of 1000 Monte Carlo simulated 5-bar total burn time for total<=maximum total burn time. For the UL-94 V-0 rating, the maximum total burn time is 50 seconds. For a V-1 or V-2 rating, the maximum total burn time is 250 seconds.

Preferably, p(FTP) is as close to 1 as possible, for example, greater than or equal to about 0.80, or greater than or equal to about 0.90, or greater than or equal to about 0.95, for maximum flame-retardant performance in UL testing. These standards are more stringent than merely specifying compliance with the referenced V-0 or V-1 test.

For the CTI values reported in the Examples, drops of 0.1% ammonium chloride solution were applied, the voltage was maintained at 250V, and the number of drops needed to cause tracking was counted. The higher the number of drops, the higher the tracking resistance of the Example was. In order to meet CTI PLC 2 standards, the number of drops must be 50 or higher.

### First Set of Examples

Table 1 shows the properties of polycarbonate blends containing BPADP or DPP at two different levels of phosphorus. CEx-1 was a reference sample containing no phosphorus at all. CEx-2 and CEx-3 used BPADP, while CEx-4 and CEx-5 used DPP. The amounts of each flame retardant were controlled to arrive at the same total amount of phosphorus in the blend. Because DPP contains more phosphorus than BPADP, a lower level of DPP is needed to attain the same level of phosphorus in the final formulation.

As seen in CEx-2, at 0.18% phosphorus using BPADP, no solid 1 mm V0 rating is attained; the pFTP(V0) is very low. Compared to Ex-1, the same amount of phosphorus from DPP provides lower FOT and higher pFTP(V0) levels.

As seen in CEx-3, BPADP can give a solid 1 mm V0 at higher levels. However, both the Vicat temperature and the INI drop severely. Looking at CEx-5, the Vicat and INI do not drop as much.

### Second Set of Examples

Tables 2A and 2B show that a better balance of properties can be attained at lower levels of DPP. At levels greater than 3.5% of DPP, a 0.8 mm V0 rating is attained, while maintaining a good enough heat resistance to pass the BPT test at 125° C. Reducing the TSAN level to 0.3% further improves the FR robustness. When using carbon black as well to attain a darker color, only 2.5% DPP is needed.

### Third Set of Examples

Table 3 shows two additional examples. Interestingly, the addition of carbon black improved the 0.8 mm V0 rating.

TABLE 1

| | | | | CEx-1 | | CEx-2 | | CEx-3 | | CEx-4 | | CEx-5 | |
|---|---|---|---|---|---|---|---|---|---|---|---|---|---|
| PC-1 (Mw 30,500) | | | % | 39.52 | | 38.52 | | 37.52 | | 38.835 | | 38.15 | |
| PC-2 (Mw 21,800) | | | % | 39.52 | | 38.52 | | 37.52 | | 38.835 | | 38.15 | |
| PC-ST | | | % | 20 | | 20 | | 20 | | 20 | | 20 | |
| BPADP | | | % | — | | 2 | | 4 | | — | | — | |
| DPP | | | % | — | | — | | — | | 1.37 | | 2.74 | |
| Additives | | | % | 0.96 | | 0.96 | | 0.96 | | 0.96 | | 0.96 | |
| % P | | | | 0% | | 0.18% | | 0.36% | | 0.18% | | 0.36% | |
| MVR 300° C., 1.2 kg | | | cm³/10 min | 8.0 | | 8.8 | | 11.4 | | 8.7 | | 9.3 | |
| Vicat | B120 | | ° C. | 144.1 | | 135.4 | | 126.8 | | 139.9 | | 135.9 | |
| INI, Impact | 23° | C. | kJ/m² | 72 | | 74 | | 67 | | 76 | | 75 | |
| INI, Impact | 0° | C. | kJ/m² | 71 | | 71 | | 61 | | 70 | | 73 | |
| INI, Impact | −20° | C. | kJ/m² | 66 | | 60 | | 51 | | 64 | | 69 | |
| INI, Impact | −30° | C. | kJ/m² | 62 | | 57 | | 22 | | 64 | | 62 | |
| INI, Impact | −40° | C. | kJ/m² | 59 | | 48 | | 19 | | 59 | | 56 | |
| INI, Ductility | 23° | C. | % | 100 | | 100 | | 100 | | 100 | | 100 | |
| INI, Ductility | 0° | C. | % | 100 | | 100 | | 100 | | 100 | | 100 | |
| INI, Ductility | −20° | C. | % | 100 | | 100 | | 100 | | 100 | | 100 | |
| INI, Ductility | −30° | C. | % | 100 | | 100 | | 0 | | 100 | | 100 | |
| INI, Ductility | −40° | C. | % | 100 | | 100 | | 0 | | 100 | | 100 | |
| UL94 V0 | 1 | mm | | t1 | t2 | t1 | t2 | t1 | t2 | t1 | t2 | t1 | t2 |
| | | | | 2.5 | 19.1 | 3.2 | 2.3 | 1.7 | 5.9 | 1.3 | 2.3 | 1.5 | 2.7 |
| | | | | 29.3 | 4.4 | 4.9 | 6.9 | 1.6 | 2.1 | 5.2 | 8.0 | 3.8 | 3.7 |
| | | | | 16.7 | 2.9 | 1.8 | 5.1 | 1.6 | 5.2 | 1.4 | 2.3 | 4.0 | 2.3 |
| | | | | 7.0 | 5.5 | 1.9 | 6.6 | 1.5 | 4.9 | 2.8 | 3.6 | 4.8 | 2.4 |
| | | | | 6.1 | 9.1 | 1.4 | 8.6 | 1.8 | 3.5 | 4.7 | 2.9 | 2.1 | 3.9 |
| FOT (5-bars) | 1 | mm | sec | 102.6 | | 42.7 | | 29.8 | | 34.5 | | 31.2 | |
| drips | 1 | mm | | 0 | | 0 | | 0 | | 0 | | 0 | |
| pFTP (V0) | 1 | mm | — | 0.00 | | 0.42 | | 0.93 | | 0.79 | | 0.97 | |
| UL94 V0 | 1.5 | mm | | t1 | t2 | t1 | t2 | t1 | t2 | t1 | t2 | t1 | t2 |

| | | | | | | | | | |
|---|---|---|---|---|---|---|---|---|---|
| 1.0 | 6.2 | 1.0 | 1.1 | 0.9 | 1.2 | 0.8 | 1.1 | 0.8 | 1.0 |
| 2.6 | 5.5 | 2.2 | 1.5 | 0.9 | 1.3 | 0.8 | 1.0 | 0.8 | 0.9 |
| 1.7 | 4.4 | 0.8 | 1.2 | 1.1 | 1.2 | 0.8 | 1.2 | 0.9 | 0.9 |
| 0.9 | 2.1 | 1.5 | 1.2 | 1.2 | 1.4 | 0.8 | 0.8 | 0.8 | 0.8 |
| 1.5 | 3.3 | 1.0 | 1.2 | 0.9 | 1.1 | 0.8 | 0.8 | 0.9 | 0.8 |

| | | | | | | | | |
|---|---|---|---|---|---|---|---|---|
| FOT (5-bars) | 1.5 | mm | sec | 29.2 | 12.7 | 11.2 | 8.9 | 8.6 |
| drips | 1.5 | mm | | 0 | 0 | 0 | 0 | 0 |
| pFTP (V0) | 1.5 | mm | — | 0.91 | 1.00 | 1.00 | 1.00 | 1.00 |

*Additives: 0.3% TSAN, 0.3% PETS, 0.06% phosphite, 0.3% UVA-234

TABLE 2A

| | | | | CEx-6 | CEx-7 | Ex-1 | Ex-2 |
|---|---|---|---|---|---|---|---|
| PC-1 (Mw 30,500) | | | % | 38.17 | 37.92 | 37.67 | 37.42 |
| PC-2 (Mw 21,800) | | | % | 38.17 | 37.92 | 37.67 | 37.42 |
| PC-ST | | | % | 15 | 15 | 15 | 15 |
| DPP | | | % | 2.5 | 3 | 3.5 | 4 |
| TSAN | | | % | 0.5 | 0.5 | 0.5 | 0.5 |
| Additives* | | | % | 0.66 | 0.66 | 0.66 | 0.66 |
| TiO₂ | | | % | 5 | 5 | 5 | 5 |
| carbon black | | | % | — | — | — | — |
| MVR 300° C., 1.2 kg | | | cm³/10 min | 10.1 | 10.2 | 11.4 | 11.7 |
| Vicat | B120 | | ° C. | 136.5 | 135.0 | 133.6 | 132.9 |
| BPT indentation | 125° | C. | mm | 1.1 | 1.3 | 1.6 | 1.6 |
| pass/fail | 125° | C. | — | pass | pass | pass | pass |
| INI, Impact | 23° | C. | kJ/m² | 55 | 54 | 54 | 54 |
| INI, Impact | −30° | C. | kJ/m² | 38 | 42 | 40 | 35 |
| INI, Impact | −40° | C. | kJ/m² | 36 | 26 | 24 | 17 |
| INI, Ductility | 23° | C. | % | 100 | 100 | 100 | 100 |
| INI, Ductility | −30° | C. | % | 100 | 100 | 100 | 100 |
| INI, Ductility | −40° | C. | % | 40 | 0 | 0 | 0 |

| 0.8 mm V0 | t1 | t2 | t1 | t2 | t1 | t2 | t1 | t2 |
|---|---|---|---|---|---|---|---|---|
| | 2.5 | 17.5 | 2.5 | 7.4 | 1.4 | 3.3 | 1.8 | 4.1 |
| | 2.9 | 1.6 | 2.3 | 1.6 | 1.0 | 3.4 | 3.0 | 2.8 |
| | 3.3 | 17.9 | 2.5 | 4.7 | 2.1 | 3.8 | 1.2 | 2.1 |
| | 1.8 | 1.5 | 2.2 | 7.5 | 1.9 | 3.1 | 1.0 | 1.3 |
| | 2.6 | 8.3 | 2.7 | 6.6 | 2.4 | 1.4 | 1.9 | 1.8 |
| | 2.6 | 2.4 | 5.4 | 2.7 | 2.0 | 7.7 | 1.2 | 4.7 |
| | 2.7 | 4.0 | 2.1 | 7.3 | 2.7 | 3.4 | 1.1 | 2.4 |
| | 2.3 | 11.6 | 2.4 | 8.4 | 2.0 | 10.1 | 2.2 | 1.3 |
| | 2.8 | 3.6 | 6.3 | 2.7 | 1.8 | 7.7 | 2.1 | 1.4 |
| | 3.4 | 1.5 | 2.5 | 8.0 | 1.1 | 1.6 | 1.9 | 1.4 |

| | | | | | | | |
|---|---|---|---|---|---|---|---|
| FOT (10-bars) | 0.8 | mm | sec | 48.4 | 43.9 | 32.0 | 20.4 |
| Drips | 0.8 | mm | | 0 | 0 | 0 | 0 |
| pFTP (V0) | 0.8 | mm | — | 0.16 | 0.40 | 0.69 | 1.00 |
| CTI | 250 | V | drops | 100 | 91 | 100 | 100 |

*additives: 0.3% PETS, 0.06% phosphite, 0.3% UV

TABLE 2B

| | | | | Ex-3 | Ex-4 | Ex-5 | CEx-8 | Ex-6 |
|---|---|---|---|---|---|---|---|---|
| PC-1 (Mw 30,500) | | | % | 37.77 | 37.57 | 38.92 | 36.42 | 34.52 |
| PC-2 (Mw 21,800) | | | % | 37.77 | 37.57 | 38.92 | 36.42 | 34.52 |
| PC-ST | | | % | 15 | 15 | 15 | 15 | 22.5 |
| DPP | | | % | 3.5 | 3.5 | 3.5 | 3.5 | 2.5 |
| TSAN | | | % | 0.3 | 0.7 | 0.5 | 0.5 | 0.3 |
| Additives* | | | % | 0.66 | 0.66 | 0.66 | 0.66 | 0.66 |
| TiO₂ | | | % | 5 | 5 | 2.5 | 7.5 | 4 |
| carbon black | | | % | — | — | — | — | 1 |
| MVR 300° C., 1.2 kg | | | cm³/10 min | 12.0 | 10.2 | 10.6 | 10.3 | 8.9 |
| Vicat | B120 | | ° C. | 134.0 | 133.3 | 134.5 | 133.7 | 137.3 |
| BPT indentation | 125° | C. | Mm | 1.6 | 1.7 | 1.4 | 1.6 | 1.3 |
| pass/fail | 125° | C. | — | pass | pass | pass | pass | pass |
| INI, Impact | 23° | C. | kJ/m² | 52 | 53 | 58 | 53 | 55 |
| INI, Impact | −30° | C. | kJ/m² | 39 | 34 | 34 | 38 | 39 |
| INI, Impact | −40° | C. | kJ/m² | 34 | 18 | 17 | 23 | 24 |
| INI, Ductility | 23° | C. | % | 100 | 100 | 100 | 100 | 100 |
| INI, Ductility | −30° | C. | % | 100 | 80 | 80 | 100 | 100 |
| INI, Ductility | −40° | C. | % | 0 | 0 | 0 | 0 | 0 |

| 0.8 mm V0 | t1 | t2 | t1 | t2 | t1 | t2 | t1 | t2 | t1 | t2 |
|---|---|---|---|---|---|---|---|---|---|---|
| | 2.4 | 4.0 | 2.0 | 4.9 | 2.3 | 2.6 | 2.2 | 1.6 | 1.9 | 5.2 |
| | 1.7 | 2.9 | 2.4 | 1.6 | 1.0 | 4.7 | 1.0 | 12.3 | 1.2 | 1.5 |
| | 2.0 | 2.9 | 2.0 | 1.6 | 2.5 | 2.3 | 1.2 | 7.9 | 1.0 | 1.3 |
| | 2.6 | 6.3 | 2.6 | 3.0 | 1.6 | 2.7 | 2.0 | 4.3 | 1.2 | 1.5 |
| | 2.2 | 1.9 | 1.1 | 4.1 | 2.3 | 5.7 | 2.6 | 7.2 | 4.7 | 1.5 |
| | 1.6 | 3.2 | 1.0 | 1.3 | 2.4 | 3.6 | 2.2 | 9.3 | 1.1 | 5.4 |
| | 1.4 | 4.0 | 2.3 | 3.1 | 3.5 | 4.5 | 1.8 | 13.4 | 1.8 | 3.1 |
| | 1.8 | 4.2 | 1.2 | 8.6 | 2.9 | 2.5 | 1.0 | 6.4 | 1.3 | 1.5 |
| | 2.0 | 5.3 | 2.5 | 1.7 | 2.0 | 5.9 | 2.5 | 10.1 | 1.9 | 1.8 |
| | 3.2 | 2.9 | 1.0 | 5.2 | 2.3 | 2.4 | 1.5 | 9.4 | 2.0 | 2.5 |

| | | | | | | | | |
|---|---|---|---|---|---|---|---|---|
| FOT (10-bars) | 0.8 | mm | Sec | 29.3 | 26.6 | 29.9 | 50.0 | 21.7 |
| drips | 0.8 | mm | | 0 | 0 | 0 | 0 | 0 |
| pFTP (V0) | 0.8 | mm | — | 0.99 | 0.88 | 0.99 | 0.08 | 0.99 |
| CTI | 250 | V | Drops | 100 | 88 | 97 | 100 | 54 |

*additives: 0.3% PETS, 0.06% phosphite, 0.3% UV

TABLE 3

| | | | | Ex-7 | Ex-8 |
|---|---|---|---|---|---|
| PC-1 (Mw 30,500) | | | % | 36.77 | 36.52 |
| PC-2 (Mw 21,800) | | | % | 36.77 | 36.52 |
| PC-ST | | | % | 15 | 15 |
| DPP | | | % | 4 | 4 |
| TSAN | | | % | 0.3 | 0.3 |
| Additives* | | | % | 0.66 | 0.66 |
| TiO₂ | | | % | 6.5 | 6.5 |
| carbon black | | | % | | 0.5 |
| MVR 300° C., 1.2 kg | | | cm³/10 min | 12.7 | 12.4 |
| Vicat | B120 | | ° C. | — | — |
| BPT | 125° | C. | mm | 1.9 | 1.9 |
| indentation | | | | | |
| pass/fail | 125° | C. | — | pass | Pass |
| INI, Impact | 23° | C. | kJ/m² | 71 | 64 |
| INI, Impact | −30° | C. | kJ/m² | 50 | 38 |
| INI, Impact | −40° | C. | kJ/m² | 32 | 23 |
| INI, Ductility | 23° | C. | % | 100 | 100 |
| INI, Ductility | −30° | C. | % | 100 | 80 |
| INI, Ductility | −40° | C. | % | 0 | 0 |

| | t1 | t2 | t1 | t2 |
|---|---|---|---|---|
| 0.8 mm V0 | 6.6 | 2.0 | 1.1 | 1.4 |
| | 1.0 | 3.9 | 1.5 | 1.4 |
| | 0.9 | 1.6 | 1.3 | 4.5 |
| | 2.9 | 7.6 | 1.9 | 2.9 |
| | 1.9 | 5.8 | 1.3 | 1.8 |
| | 5.1 | 2.4 | 4.1 | 1.1 |
| | 1.2 | 12.8 | 1.7 | 1.4 |
| | 2.4 | 5.9 | 1.4 | 1.9 |
| | 1.2 | 5.7 | 1.0 | 3.3 |
| | 4.0 | 1.8 | 1.2 | 1.8 |

| | | | | | |
|---|---|---|---|---|---|
| FOT (10-bars) | 0.8 | mm | sec | 76.7 | 38.0 |
| drips | 0.8 | mm | | 0% | 0% |
| pFTP (V0) | 0.8 | mm | — | 0.48 | 1.00 |
| CTI | 250 | V | drops | 100 | 100 |

Set forth below are some embodiments of the blends disclosed herein.

### Embodiment 1

A flame-retardant polycarbonate blend, comprising: from about 30 wt % to about 80 wt % of a polycarbonate polymer; a polycarbonate-polysiloxane copolymer in an amount such that the blend contains from about 2 wt % to about 5 wt % of siloxane; and a phosphazene flame retardant in an amount such that the blend contains from about 0.1 wt % to about 0.7 wt % of phosphorus; wherein the polycarbonate blend meets CTI PLC 2 standards and has V0 performance at 1.5 mm thickness.

### Embodiment 2

The polycarbonate blend of Embodiment 1, wherein the blend has V0 performance at 0.8 mm thickness.

### Embodiment 3

The polycarbonate blend of any of Embodiments 1-2, wherein the blend passes the BPT at 125° C.

### Embodiment 4

The polycarbonate blend of any of Embodiments 1-3, wherein the blend has 100% ductility at −30° C. when measured under Izod notched impact according to ISO 180.

### Embodiment 5

The polycarbonate blend of any of Embodiments 1-4, wherein the blend has an MVR of 8 cm³/10 min or higher when measured at 300° C., 1.2 kg according to ISO 1133.

### Embodiment 6

The polycarbonate blend of any of Embodiments 1-5, wherein the blend has a notched Izod impact strength at −30° C. of at least 25 kJ/m² when measured according to ISO 180.

### Embodiment 7

The polycarbonate blend of any of Embodiments 1-6, wherein the blend has V0 performance at 0.8 mm thickness; has 100% ductility at −30° C. when measured under Izod notched impact according to ISO 180; has an MVR of 8 cm³/10 min or higher when measured at 300° C., 1.2 kg according to ISO 1133; and passes the BPT at 125° C.

### Embodiment 8

The polycarbonate blend of any of Embodiments 1-7, wherein the blend has a pFTP(V0) of at least 0.90 and a flame out time (FOT) of about 30 seconds or less at 0.8 mm thickness.

### Embodiment 9

The polycarbonate blend of any of Embodiments 1-8, wherein the blend has a pFTP(V0) of at least 0.95 and a flame out time (FOT) of about 25 seconds or less at 0.8 mm thickness.

### Embodiment 10

The polycarbonate blend of any of Embodiments 1-9, further comprising from about 2 wt % to about 10 wt % of titanium dioxide (TiO₂).

### Embodiment 11

The polycarbonate blend of any of Embodiments 1-10, wherein the blend contains from about 14 wt % to about 24 wt % of the polycarbonate-polysiloxane copolymer.

### Embodiment 12

The polycarbonate blend of any of Embodiments 1-11, wherein the blend contains from about 1 wt % to about 4 wt % of the phosphazene flame retardant.

### Embodiment 13

The polycarbonate blend of any of Embodiments 1-12, further comprising from about 0.2 wt % to about 0.6 wt % of an anti-drip agent.

### Embodiment 14

The polycarbonate blend of any of Embodiments 1-13, wherein the polycarbonate polymer comprises a high molecular weight polycarbonate polymer having a Mw above 25,000 and a low molecular weight polycarbonate polymer having a Mw below 25,000.

### Embodiment 15

The polycarbonate blend of Embodiment 14, wherein the weight ratio of the high molecular weight polycarbonate polymer to the low molecular weight polycarbonate polymer is about 1:1.

### Embodiment 16

The polycarbonate blend of any of Embodiments 1-15, wherein the phosphazene flame retardant has the structure of Formula (II) or Formula (III):

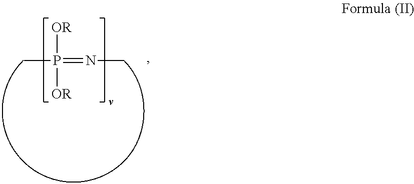

wherein R is alkyl or aryl; and wherein v is an integer from 3 to 25;

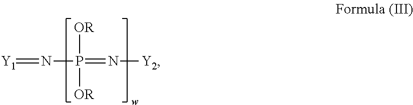

wherein R is alkyl or aryl; w is an integer from 3 to about 1,000; Y₁ is —P(OR)₃ or —P(═O)(OR); and Y₂ is —P(OR)₄ or —P(═O)(OR)₂.

### Embodiment 17

The polycarbonate blend of any of Embodiments 1-16, further comprising from greater than 0 to 2 wt % of carbon black.

### Embodiment 18

The polycarbonate blend of any of Embodiments 1-17, wherein the blend does not contain a copolymer of bisphenol-A and 2-phenyl-3,3-bis(4-hydroxyphenyl) phthalimidine.

### Embodiment 19

A flame-retardant polycarbonate blend, comprising: from about 35 wt % to about 45 wt % of a high molecular weight polycarbonate polymer having a Mw above 25,000; from about 35 wt % to about 45 wt % of a low molecular weight polycarbonate polymer having a Mw below 25,000; from about 14 wt % to about 24 wt % of a polycarbonate-polysiloxane copolymer; from about 1.0 wt % to about 4.0 wt % of a phosphazene flame retardant; and from about 2.0 wt % to about 7.0 wt % of TiO₂; wherein the blend meets CTI PLC 2 standards, has V0 performance at 0.8 mm thickness, and passes the BPT at 125° C.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A flame-retardant polycarbonate blend, comprising:
from about 30 wt % to about 80 wt % of a polycarbonate polymer;
a polycarbonate-polysiloxane copolymer in an amount such that the blend contains from about 2 wt % to about 5 wt % of siloxane; and
a phosphazene flame retardant in an amount such that the blend contains from about 0.1 wt % to about 0.7 wt % of phosphorus;
wherein the polycarbonate blend meets CTI PLC 2 standards and has V0 performance at 1.5 mm thickness.

2. The polycarbonate blend of claim 1, wherein the blend has V0 performance at 0.8 mm thickness.

3. The polycarbonate blend of claim 1, wherein the blend passes the ball pressure test (BPT) at 125° C.

4. The polycarbonate blend of claim 1, wherein the blend has 100% ductility at −30° C. when measured under Izod notched impact according to ISO 180.

5. The polycarbonate blend of claim 1, wherein the blend has an MVR of 8 cm³/10 min or higher when measured at 300° C., 1.2 kg according to ISO 1133.

6. The polycarbonate blend of claim 1, wherein the blend has a notched Izod impact strength at −30° C. of at least 25 kJ/m² when measured according to ISO 180.

7. The polycarbonate blend of claim 1, wherein the blend has V0 performance at 0.8 mm thickness; has 100% ductility at −30° C. when measured under Izod notched impact according to ISO 180; has an MVR of 8 cm³/10 min or higher when measured at 300° C., 1.2 kg according to ISO 1133; and passes the ball pressure test (BPT) at 125° C.

8. The polycarbonate blend of claim 1, wherein the blend has a pFTP(V0) of at least 0.90 and a flame out time (FOT) of about 30 seconds or less at 0.8 mm thickness.

9. The polycarbonate blend of claim 1, wherein the blend has a pFTP(V0) of at least 0.95 and a flame out time (FOT) of about 25 seconds or less at 0.8 mm thickness.

10. The polycarbonate blend of claim 1, further comprising from about 2 wt % to about 10 wt % of titanium dioxide (TiO₂).

11. The polycarbonate blend of claim 1, wherein the blend contains from about 14 wt % to about 24 wt % of the polycarbonate-polysiloxane copolymer.

12. The polycarbonate blend of claim 1, wherein the blend contains from about 1 wt % to about 4 wt % of the phosphazene flame retardant.

13. The polycarbonate blend of claim 1, further comprising from about 0.2 wt % to about 0.6 wt % of an anti-drip agent.

14. The polycarbonate blend of claim 1, wherein the polycarbonate polymer comprises a high molecular weight polycarbonate polymer having a Mw above 25,000 and a low molecular weight polycarbonate polymer having a Mw below 25,000.

15. The polycarbonate blend of claim 14, wherein the weight ratio of the high molecular weight polycarbonate polymer to the low molecular weight polycarbonate polymer is about 1:1.

16. The polycarbonate blend of claim 1, wherein the phosphazene flame retardant has the structure of Formula (II) or Formula (III): 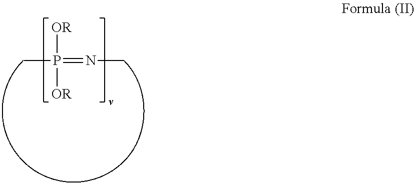
wherein R is alkyl or aryl; and wherein v is an integer from 3 to 25; 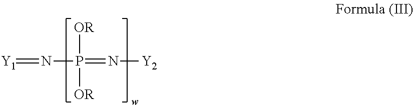
wherein R is alkyl or aryl; w is an integer from 3 to about 1,000; Y₁ is —P(OR)₃ or −P(═O)(OR); and Y₂ is —P(OR)₄ or —P(═O)(OR)₂.

17. The polycarbonate blend of claim 1, further comprising from greater than 0 to 2 wt % of carbon black.

18. The polycarbonate blend of claim 1, wherein the blend does not contain a copolymer of bisphenol-A and 2-phenyl-3,3-bis(4-hydroxyphenyl) phthalimidine.

19. A flame-retardant polycarbonate blend, comprising:
from about 35 wt % to about 45 wt % of a high molecular weight polycarbonate polymer having a Mw above 25,000;
from about 35 wt % to about 45 wt % of a low molecular weight polycarbonate polymer having a Mw below 25,000;
from about 14 wt % to about 24 wt % of a polycarbonate-polysiloxane copolymer;
from about 1.0 wt % to about 4.0 wt % of a phosphazene flame retardant; and
from about 2.0 wt % to about 7.0 wt % of titanium dioxide (TiO₂);
wherein the blend meets CTI PLC 2 standards, has V0 performance at 0.8 mm thickness, and passes the ball pressure test (BPT) at 125° C.
